(19) United States
(12) Patent Application Publication
(10) Pub. No.: US 2016/0057367 A1
(43) Pub. Date: Feb. 25, 2016

(54) METHOD FOR EXTRACTING RGB AND NIR USING RGBW SENSOR

(71) Applicant: Hyundai Motor Company, Seoul (KR)

(72) Inventor: Seok Beom Lee, Seoul (KR)

(21) Appl. No.: 14/569,722

(22) Filed: Dec. 14, 2014

(30) Foreign Application Priority Data
Aug. 25, 2014 (KR) 10-2014-0110944

(51) Int. Cl. H04N 5/33; G06K 9/00; G02B 5/20; H04N 9/04; H04N 5/235

(52) U.S. Cl. CPC H04N 5/33; H04N 9/045; H04N 5/2353; G02B 5/208; G06K 9/00255; G06K 9/00832

(57) ABSTRACT

A method is provided for extracting RGB and NW using an RGBW sensor that improves image information processing performance by simultaneously extracting RGB and NIR image information using the RGBW sensor in which pixels of an RGB filter and pixels of a clear filter are coupled, and reducing cost by extracting the NIR image information while not using an infrared cutoff filter is provided. The method includes transmitting, by light, an RGBW filter, and extracting an RGBW image value (R_c, G_c, B_c, W_c) captured by sensing the transmitted light by the RGBW sensor and extracting an RGB value. In addition, the method includes an NIR value by multiplying the captured RGBW image value with an inverse matrix (A) value.

### CROSS-REFERENCE TO RELATED APPLICATION(S)

Pursuant to 35 U.S.C. §119(a), this application is based on and claims the benefit of priority to Korean Patent Application No. 10-2014-0110944, filed on Aug. 25, 2014, the disclosure of which is incorporated herein in its entirety by reference.

### TECHNICAL FIELD

The present disclosure relates to a system and method for extracting red, blue green (RGB) and near infrared (NW) light using an red, green, blue, white (RGBW) sensor, and more particularly, to a technology capable of simultaneously extracting RGB and NW information using an RGBW sensor while not using an infrared cutoff filter.

### BACKGROUND

An imaging device, (e.g., a camera, a video camera or the like) installed within a vehicle to monitor a driver state may be configured to obtain an image in day light and at night, in a no light state, while not interrupting night time driving by using NW lighting. Particularly, an NW pass (or cut) filter and an RGB cut filter are used in the imaging device to prevent image distortion due to sunlight during the day. The NIR pass filter and the RGB cut filter are used with the imaging device to prevent RGB values associated with the headlights of other vehicles and street lights from causing imaging errors at night.

When the NW pass filter and the RGB cut filter are respectively used for the imaging device, costs associated with manufacturing the imaging device may increase due to the high costs of the NIR pass filter. In addition, an RGB and NW filter array structure in which the RGB filter and the NW filter are coupled, may simultaneously extract NIR information and RGB information and may perform a color based face detection by estimating an external lighting environment. However, since the NIR filter is expensive, use of such coupled RGB and NW filters would also increase costs of manufacturing an associated imaging device.

### SUMMARY

The present invention provides a method for extracting RGB and NW using an RGBW sensor capable of improving image information processing performance by simultaneously extracting RGB and NIR information using the RGBW sensor in which pixels of an RGB filter and pixels of a clear filter are coupled, and reducing cost by extracting the NIR information while not using an infrared cutoff filter.

According to an exemplary embodiment of the present invention, a method for extracting RGB and NW using an RGBW sensor may include: transmitting, by light, an RGBW filter; extracting an RGBW image value (R_c, G_c, B_c, W_c) captured by sensing the transmitted light by the RGBW sensor; and extracting an RGB value and an NW value by multiplying the captured RGBW image value with an inverse matrix (A) value.

The RGBW filter may include an RGB filter and a clear filter. The RGBW image value (R_c, G_c, B_c, W_c) may be extracted by respectively sensing red light R, green light G, blue light B, and infrared IR of the light as Sat(a_R*(R+IR)*DelT), Sat(a_G*(G+IR)*DelT), Sat(a_B*(B+IR)* DelT) and Sat(a_W*(R+G+B+IR)*DelT). In the extraction of the RGBW image value (R_c, G_c, B_c, W_c), the RGBW image value may be extracted according to color saturation by adjusting light efficiency and light exposure time. The RGB value and the NIR value may be extracted by multiplying the RGBW image value with the inverse matrix value when the RGBW sensor is not saturated.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary diagram describing a method for calculating an RGBW image value which is captured using an RGBW sensor according to an exemplary embodiment of the present disclosure;

FIG. 2 is an exemplary diagram describing a method for extracting an RGB value and an NIR value from the RGBW image value according to an exemplary embodiment of the present disclosure; and

FIG. 3 is an exemplary flow chart describing a method for detecting a face of a driver using the NIR value according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The above-mentioned objects, features, and advantages will become obvious from the detailed description which is described below in detail with reference to the accompanying drawings. Therefore, those skilled in the art to which the present disclosure pertains may easily practice a technical idea of the present disclosure. Further, in describing the present disclosure, when it is determined that a detailed description of a well-known technology associated with the present disclosure may unnecessarily make unclear the gist of the present disclosure, it will be omitted. Hereinafter, exemplary embodiments of the present disclosure will be described in detail with reference to the accompanying drawings.

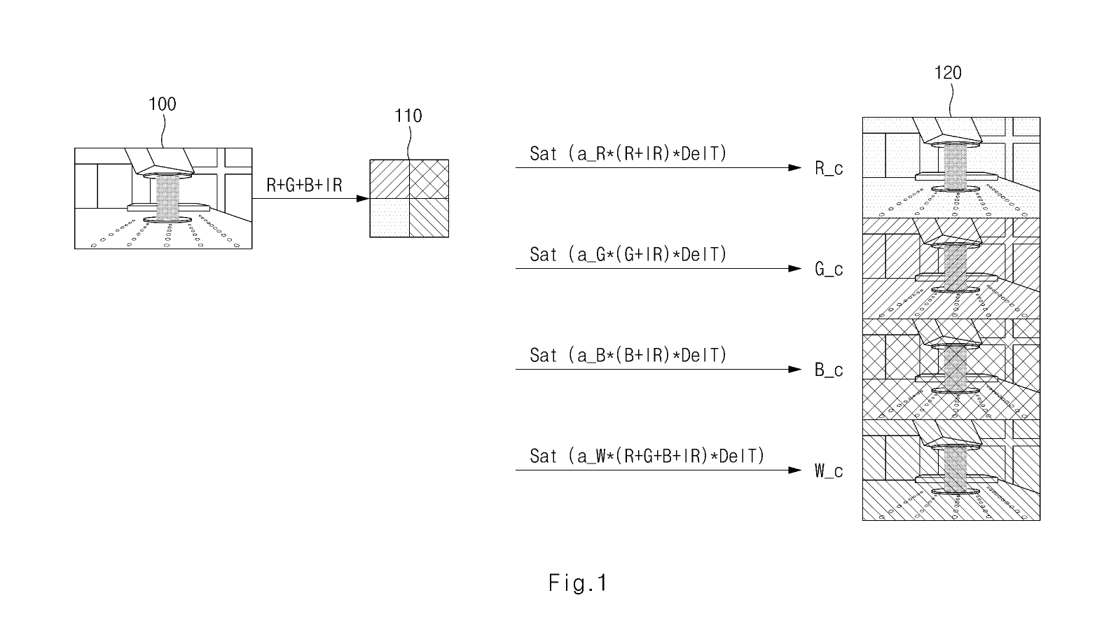

FIG. 1 is an exemplary diagram describing a method for calculating an RGBW image value which is captured using an RGBW sensor according to an exemplary embodiment of the present invention. Referring to FIG. 1, a light source 100 may include red light R, green light G, blue light B, and infrared IR light. Various wavelengths of light included in the light source 100 transmit an RGBW filter and an RGBW image value 120 captured by sensing the transmitted lights by an RGBW sensor 110 may be extracted. In particular, the RGBW filter may be configured as a unitary filter by incorporating an RGB filter and a clear filter. Red light, green light, blue light, and infrared light which pass through the RGBW filter may be converted into output values of red, green, blue, and white, respectively. The RGBW filter may include the RGB filter and the clear filter, wherein the clear filter, (e.g., a transparent filter), is similar to a lens protective filter.

For example, an imaging device may include microlenses, configured to receive light, and may be disposed on a top of the RGBW filter and may include the RGBW sensor 110 configured to sense signals which pass through the RGBW filter. Alternatively, the microlenses may be disposed on a bottom of the RGBW filter. According to the related art, an NIR cut-off filter may be provided on the top of the RGB filter in order to cut-off concentration of IR components and an NIR pass filter may be disposed on a top of an IR filter in order to perform the concentration of the IR components. However, according to exemplary embodiments of the present invention, since the NW cut-off filter is not required to be disposed on the top of the RGB filter and the clear filter is used, the NIR pass filter may not be used.

Specifically, red light R, green light G, blue light B, and infrared IR included in the light source 100 transmit the RGBW filter and are sensed as Sat(a_R*(R+IR)*DelT), Sat(a_G*(G+IR)* DelT), Sat(a_B*(3+IR)*DelT) and Sat(a_W*(R+G+B+IR)*DelT) by the RGBW sensor 110, such that the captured RGBW image value 120 may be output. The RGBW image value 120 may be represented as R_c, G_c, B_c, or W_c value. Further, a_R*, a_G*, a_B*and a_W*represent light filtering efficiencies by the RGB filter and the clear filter, DelT is an exposure time, and Sat is color saturation.

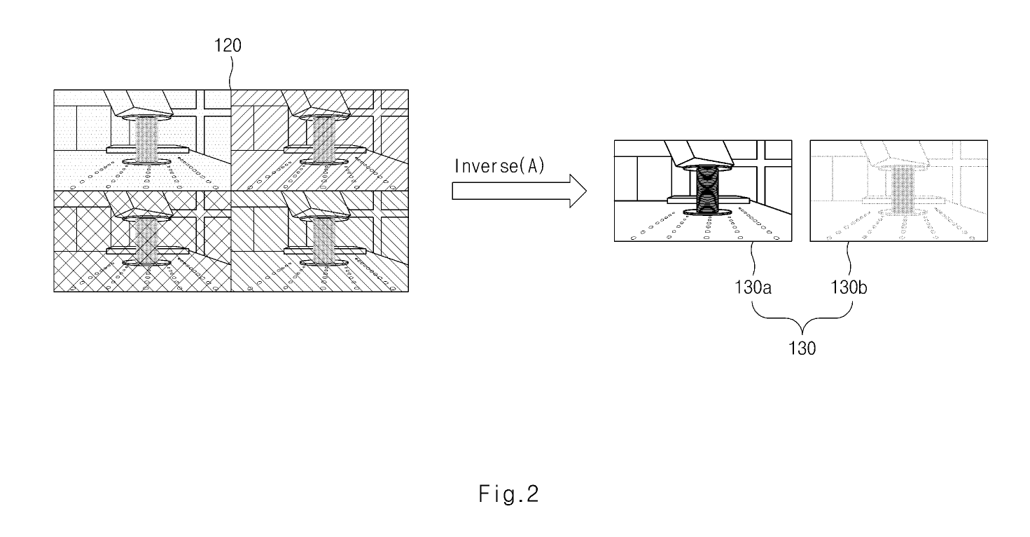

FIG. 2 is an exemplary diagram describing a method for extracting an RGB value and an NIR value from the RGBW image value according to an exemplary embodiment of the present invention. Referring to FIG. 2, the RGBW image value 120, which is R_c, G_c, B_c, or W_c, may be represented by a captured image information value and may be described by a relationship of I_c=A x I_{—}0. In particular, I_c indicates the captured RGB image value 120, I_{—}0 indicates lighting intensity (light intensity), and A is a transfer matrix value. In other words, I_c=[R_c, G_c, B_c, W_c] and I_{—}0=[R G B IR]. When NIR band efficiencies of the filter are the same, the following Equation may be satisfied.

A=[a_{—}R*DelT00 a_{—}R*DelT

0a_G*DelT0a_G*DelT

00aB*DelTaB*DelT

[1111]*a_W*DelT]

The above Equation may be satisfied when each sensor is not saturated, and may be calculated by I_{—}0=inverse(A)*I_c. Wherein, inverse(A) means an inverse matrix of A matrix. An RGB value 130a and an NW value 130b may be extracted using the above Equation. Defining the inverse matrix, in two matrixes [A] and [B], [B] satisfying [A] [B]=[1] is an inverse matrix of [A], and a relationship in this case is represented as [B]=[A]−1. In addition, [1] is referred to as a unit matrix. However, when NIR band efficiencies of the filter are different, the following Equation may be satisfied.

A=[a_{—}R*DelT, 0, 0, a_{—}RIR*DelT

0, a_G*DelT, 0, a_GIR*DelT

0,0,a_B*DelT, a_BIR*DelT

a_WR*DelT, a_WG*DelT, a_WB*DelT, a_WIR*DelT]

Wherein, a_RIR, a_GIR, a_BIR, and a_WIR respectively indicate the NW band efficiencies of the RGBW filter. An RGB value and an NIR value may be calculated using Equation of I_{—}0=inverse(A) * I_c. Here, inverse(A) means an inverse matrix of A matrix.

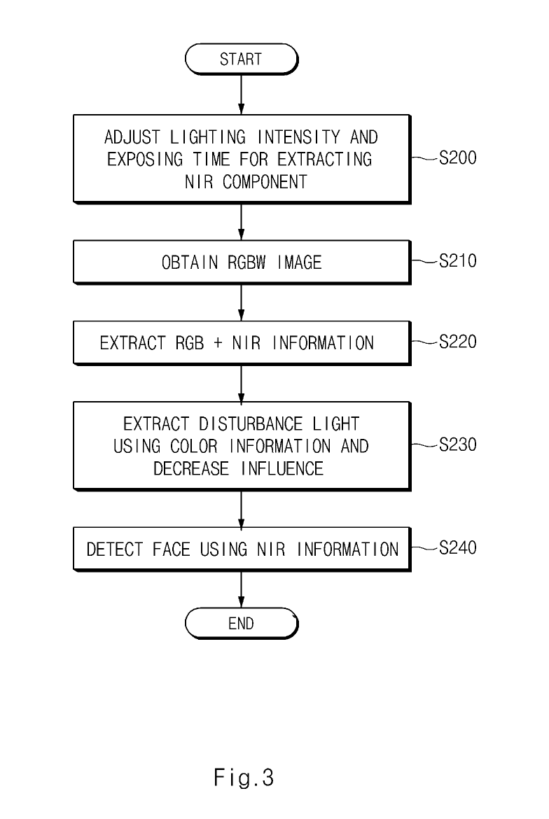

FIG. 3 is an exemplary flow chart describing a method for detecting a face of a driver using the NIR value according to an exemplary embodiment of the present invention. Referring to FIG. 3, the lighting intensity (I_{—}0) and the exposure time (DelT) for extracting the NW value from the light source may be adjusted (S200). The RGBW image value (RGBW image information) may be output (S210). The RGB value and the NW value may be extracted (S220). Further, disturbance light may be extracted using color information and influence may be decreased (S230). The type of light source surrounding a vehicle may be determined by comparing a standard skin color of a driver with a detected skin color, and intensity of an external light source may be measured using the RGB value.

Next, a face of the driver may be detected using the NW value (S240). Here, accurate face region information may be obtained using the NIR value from a face region candidate group which may be extracted using skin color information. As described above, the present technology may improve the image information processing performance by simultaneously extracting the RGB and NIR information and may reduce cost by extracting the NW information without using the infrared cut-off filter. As described above, according to the exemplary embodiments of the present invention, it may be possible to improve image information processing performance by simultaneously extracting the RGB and NIR image information. In addition, according to the exemplary embodiments of the present invention, it may be possible to reduce manufacturing costs since the NIR information may be extracted without using the infrared cutoff filter.

Although the present disclosure has been described with reference to exemplary embodiments and the accompanying drawings, it would be appreciated by those skilled in the art that the scope of the present disclosure is not limited thereto but various modifications and alterations might be made without departing from the scope defined in the claims and their equivalents.

What is claimed is:

1. A method for extracting red, green and blue light (RGB) and near infrared light (NW) using a red, green blue, white (RGBW) sensor, the method comprising:
transmitting, by light, an RGBW filter, using a light source;
extracting, by a processor, an RGBW image value (R_c, G_c, B_c, W_c) captured by sensing the transmitted light by the RGBW sensor; and
extracting, by the processor, an RGB value and an NW value by multiplying the captured RGBW image value with an inverse matrix (A) value.

2. The method according to claim 1, wherein the RGBW filter includes an RGB filter and a clear filter.

3. The method according to claim 1, wherein the RGBW image value (R_c, G_c, B_c, W_c) is extracted by respectively sensing red light R, green light G, blue light B, and infrared IR of the light as Sat(a_R*(R+IR)*DelT), Sat(a_G*(G+IR)*DelT), Sat(a_B*(3+IR) * DelT) and Sat(a_W* (R+G+B+IR)*DelT).

4. The method according to claim 1, wherein in the extracting of the RGBW image value (R_c, G_c, B_c, W_c), the RGBW image value is extracted according to color saturation by adjusting light efficiency and light exposing time.

5. The method according to claim 1, wherein the RGB value and the NW value are extracted by multiplying the RGBW image value with the inverse matrix value when the RGBW sensor is not saturated.

6. A non-transitory computer readable medium containing program instructions executed by a processor or controller for extracting red, green and blue light (RGB) and near infrared light (NIR) using a red, green blue, white (RGBW) sensor, the computer readable medium comprising:
program instructions that transmit, by light, an RGBW filter;
program instructions that extract an RGBW image value (R_c, G_c, B_c, W_c) captured by sensing the transmitted light by the RGBW sensor; and
program instructions that extract an RGB value and an NW value by multiplying the captured RGBW image value with an inverse matrix (A) value.

7. The non-transitory computer readable medium according to claim 6, wherein the RGBW filter includes an RGB filter and a clear filter.

8. The non-transitory computer readable medium according to claim 6, wherein the RGBW image value (R_c, G_c, B_c, W_c) is extracted by respectively sensing red light R, green light G, blue light B, and infrared IR of the light as Sat(a_R*(R+IR)*DelT), Sat(a_G*(G+IR)*DelT), Sat(a_B * (3+IR)*DelT) and Sat(a_W*(R+G+B+IR)*DelT).

9. The non-transitory computer readable medium according to claim 6, wherein in the extracting of the RGBW image value (R_c, G_c, B_c, W_c), the RGBW image value is extracted according to color saturation by adjusting light efficiency and light exposing time.

10. The non-transitory computer readable medium according to claim 6, wherein the RGB value and the NW value are extracted by multiplying the RGBW image value with the inverse matrix value when the RGBW sensor is not saturated.

11. A system for extracting red, green and blue light (RGB) and near infrared light (NIR) comprising:
a red, green blue, white (RGBW) sensor configured to sense transmitted RGBW light;
a light source configured to transmit by light, an RGBW filter;
a processor configured to:
extract an RGBW image value (R_c, G_c, B_c, W_c) captured by sensing the transmitted light by the RGBW sensor; and
extract an RGB value and an NIR value by multiplying the captured RGBW image value with an inverse matrix (A) value.

12. The system according to claim 11, wherein the RGBW filter includes an RGB filter and a clear filter.

13. The system according to claim 11, wherein the RGBW image value (R_c, G_c, B_c, W_c) is extracted by respectively sensing red light R, green light G, blue light B, and infrared IR of the light as Sat(a_R*(R+IR)*DelT), Sat(a_G*(G+IR)*DelT), Sat(a_B*(3+IR)*DelT) and Sat(a_W* (R+G+B+IR)*DelT).

14. The system according to claim 11, wherein the RGBW image value is extracted according to color saturation by adjusting light efficiency and light exposing time.

15. The system according to claim 11, wherein the RGB value and the NW value are extracted by multiplying the RGBW image value with the inverse matrix value when the RGBW sensor is not saturated.
